(19) United States
(12) Patent Application Publication
(10) Pub. No.: US 2007/0116989 A1
(43) Pub. Date: May 24, 2007

(54) Magnetic recording media, its fabrication technique, and hard disk drive

(76) Inventors: Hiroshi Ikekame, Fuchu (JP); Yuko Tsuchiya, Tokorozawa (JP); Masukazu Igarashi, Kawagoe (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/602,957

(22) Filed: Nov. 22, 2006

(30) Foreign Application Priority Data
Nov. 24, 2005 (JP) 2005-338388

(51) Int. Cl. G11B 5/66; B05D 5/12

(52) U.S. Cl. 428/828.1; 428/836; 427/127

(57) ABSTRACT

Provided is a medium fabrication technique, a recording medium and a hard disk drive, which achieve high recording density. To this end, (a) a magnetic layer is deposited on a substrate, and (b) a nano particle layer is deposited on the magnetic layer. Then, (c) the magnetic layer is etched by use of the nano particle layer as a mask, and (d) the nano particle layer is removed to form artificial magnetic grains, and thus an artificial granular magnetic recording medium is obtained.

### CLAIM OF PRIORITY

The present application claims priority from Japanese application JP 2005-338388 filed on Nov. 24, 2005, the content of which is hereby incorporated by reference into this application.

### BACKGROUND OF THE INVENTION

1. Field of the Invention

The present invention relates to magnetic recording media used in a hard disk drive or the like, a fabrication technique of the recording media, and a hard disk drive using the recording media.

2. Description of the Related Art

For the purpose of increasing the capacity of a hard disk drive, it suffices to increase the recording density of information recorded on magnetic recording media. In both of longitudinal magnetic recording and perpendicular magnetic recording, one of technologies necessary for increasing recording density is to reduce diameters of magnetic grains of magnetic recording media fabricated by sputtering. By reducing the grain diameters, it is possible to reduce noise generated due to the roughness and distortion (see FIG. 1A) of magnetic transition (boundary between N and S poles) of the magnetic recording media.

However, when a read or a write is attempted to be performed at surface recording density of not less than approximately 100 T (tera) bit per square meter, the attenuation (thermal demagnetization) of recorded magnetization due to thermal fluctuation (phenomenon in which the magnetization of grains is reversed by heat) becomes a serious problem along with the reduction of the diameters of magnetic grains, i.e., the reduction of volume of magnetic grains. If the diameters of magnetic grains are reduced in order to reduce noise, this phenomenon becomes more conspicuous.

Furthermore, these grain diameters actually take on values with variations (dispersion). The variations are referred to as grain diameter dispersion. In the case where the grain diameter dispersion is large, grains having large diameters to grains having small diameters are included (see FIG. 1A). However, in small grains, thermal demagnetization due to thermal fluctuation is prone to occur. That is, reducing the value of the grain diameter dispersion is also a technology necessary for increasing recording density. In Japanese Patent Laid-Open Official Gazette No. 2002-25030, proposed is a method of reducing grain diameter dispersion in a perpendicular magnetic recording granular media fabricated by sputtering.

Moreover, reducing only the grain diameters and grain diameter dispersion of magnetic crystal grains simply from the viewpoint of crystal engineering is not always good. Effectively, from the viewpoint of magnetic engineering, magnetic domains themselves need to be finer. That is, this is the problem that since magnetic exchange interaction takes place among magnetic crystal grains, magnetic domains do not become finer as compared to the diameters of crystal grains. However, with regard to this magnetic exchange interaction, smaller is not always better, and it needs to take on a certain appropriate value from the viewpoint of resolution characteristics and thermal demagnetization characteristics.

As a material for the perpendicular magnetic recording media, a material having strong magnetic anisotropy in a direction perpendicular to a film surface is necessary. In Japanese Patent Laid-Open Official Gazette No. Sho 57 (1982)-109127; Journal of Magnetics Society of Japan, Vol. 9, No. 2, pp. 57-60 (1985); IEEE Trans., MAG-24, No. 6, pp. 2706-2708 (1988); or the like, a structure is shown which is made of a hcp-CoCr alloy essentially containing Co and in which the c-axis (easy axis) thereof is perpendicular to the film surface thereof. However, since the segregation of Cr in a CoCr-alloy-based multi metal alloy perpendicular magnetic layer fabricated by sputtering is insufficient, magnetic exchange interaction among magnetic grains is strong. Thus, there is a problem that magnetic domains do not become finer and that medium noise is large. To cope with this, attempts have been made to further add a material essentially containing oxygen or an oxide such as O or SiO to a CoCr-based multi metal alloy, and proposals have been made to add oxygen or an oxide such as O or SiO to a (Co/Pt)ₙ or (Co/Pd)ₙ artificial lattice film.

Moreover, physical property parameters representing features of magnetic recording media include an anisotropic magnetic field Hk. This also takes on values with variations (dispersion) due to the fact that the composition of the medium material is uneven at the nanosize (size of magnetic grains) level. Reducing the dispersion of Hk is also an important issue for increasing recording density.

The above-described background technologies relate to granular media in which a large number of magnetic grains constitute one recorded bit. On the other hand, patterned media (dot media) in which one magnetic grain (dot) constitutes one recorded bit will be described using FIG. 1B. Since the volume occupied by one magnetic grain is large in the patterned media, a material in which the value of the uniaxial anisotropy constant (Ku) thereof is large need not be used for a recording layer in order to reduce thermal demagnetization. This makes it possible to perform recording at smaller magnetic field intensity than in the above-described continuous media (granular media). Furthermore, there is an advantage that noise due to rough, distorted magnetic transition in bit transition regions does not occur. Accordingly, patterned media have a promising potential as future high-density magnetic recording media in combination with perpendicular recording in which higher-density recording is possible than in longitudinal recording. For high-recording-density media including a perpendicular magnetic layer, a patterned medium technology (Japanese Patent Laid-Open Official Gazette No. 2001-267213 and No. 2001-332421) has been disclosed in which information is independently recorded in individual magnetic grains constituting a magnetic recording layer.

### SUMMARY OF THE INVENTION

However, when a hard disk drive is attempted to be constructed using the patterned media (dot media), a wide variety of new technologies need to be developed in the hard disk drive. Particularly important problems are that write synchronization is necessary and that read and write heads for extremely narrow tracks are necessary. Write synchronization is a technology for matching the position of a magnetic grain (dot) fabricated by patterning and the position of a write head, and energizes the write head at the timing of the write head being positioned directly above a magnetic grain. Next, the necessity for the read and write heads for extremely narrow tracks will be described. As shown in FIG. 1B, in patterned media, a bit aspect ratio BAR (ratio of a bit length to a track width of one recorded bit) is approximately one (i.e., track density is intensively increased in order to achieve high recording density). Accordingly, read and write heads for very narrower tracks become necessary than in recording in which BAR is approximately 4 as shown in FIG. 1A. If 1 Tbit/inch² is attempted to be achieved for BAR=1, both of the bit length and the track width need to be 25 nm or less.

As described above, granular media (continuous thin films) fabricated by conventional sputtering have the following problems: the reduction of all of magnetic grain diameters, grain diameter dispersion and Hk dispersion is difficult, and is also difficult to be achieved simultaneously with high thermal demagnetization resistance; the controllability of exchange interaction is poor; and the like. Even if these problems with magnetic recording media fabricated by sputtering are solved by patterned media (dot media), new challenges such as write synchronization and very narrow track heads are piled-up. Accordingly, the patterned media have poor technical compatibility with conventional technologies. Thus, it is not possible to easily provide a high-recording-density hard disk drive.

An object of the present invention is to easily provide, with good technical compatibility with conventional technologies, magnetic recording media in which an average grain diameter is not less than 1 nm and not more than 10 nm, in which grain diameter dispersion is not more than 10%, in which exchange interaction can be appropriately controlled, and in which high recording density of not less than 100 Tbit per square meter can be realized, a fabrication technique of the recording media, and a very-high-recording-density hard disk drive using the recording media.

As schematically shown in FIG. 1C, the magnetic recording media of the present invention include a granular magnetic recording layer which includes magnetic grains artificially fabricated by patterning by use of a nano particle thin film as a mask, and in which one recorded bit is recorded in the plurality of magnetic grains. The magnetic recording media are fabricated by forming a nano particle thin film over a magnetic recording layer and processing the magnetic recording layer under the nano particle thin film into fine shapes by use of the nano particle thin film as a mask. Thereafter, it also serves the purpose to add the step of removing the nano particle thin film and the step of filling in an uneven surface of the processed magnetic grains.

In the granular magnetic recording media of the present invention which include artificial magnetic grains fabricated by patterning by use of nano particles as an etching mask, it is possible to greatly improve characteristics such as grain diameters, grain diameter dispersion, Hk dispersion, thermal demagnetization resistance and exchange interaction controllability more easily than in granular magnetic recording media fabricated by the conventional sputtering. Thus, it is possible to achieve very high recording density of not less than approximately 100 Tbit per square meter. Moreover, compared to the patterned media, the granular magnetic recording media of the present invention which are fabricated by artificial patterning have good technical compatibility with conventional hard disk drive technologies. Thus, it is possible to easily provide a very-high-recording-density hard disk drive.

### BRIEF DESCRIPTION OF THE DRAWINGS

FIGS. 1A to 1C are schematic views for explaining differences among thin-film media fabricated using sputtering technology, patterned media in which one grain constitutes one recorded bit, and artificial granular magnetic recording media including magnetic grains fabricated by patterning.

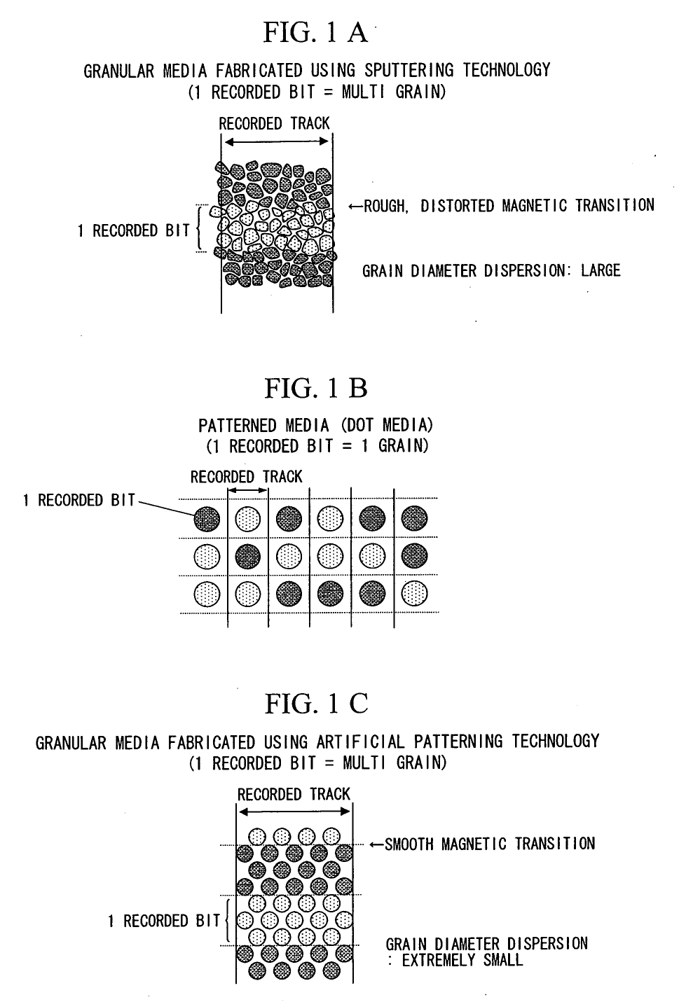

FIGS. 2A to 2F are schematic views showing a fabrication technique of artificial granular magnetic recording media including magnetic grains.

FIG. 3 is a schematic view for explaining experimental data showing optimum values of a grain area/a distance area.

FIGS. 4A to 4C are schematic views for explaining a method of adjusting exchange interaction among magnetic grains fabricated by patterning.

FIGS. 5A to 5E are schematic views showing examples 1 and 2.

FIGS. 6A to 6F are schematic views showing example 3.

FIG. 7 is a schematic view showing a hard disk drive according to the present invention.

### DESCRIPTION OF THE PREFERRED EMBODIMENTS

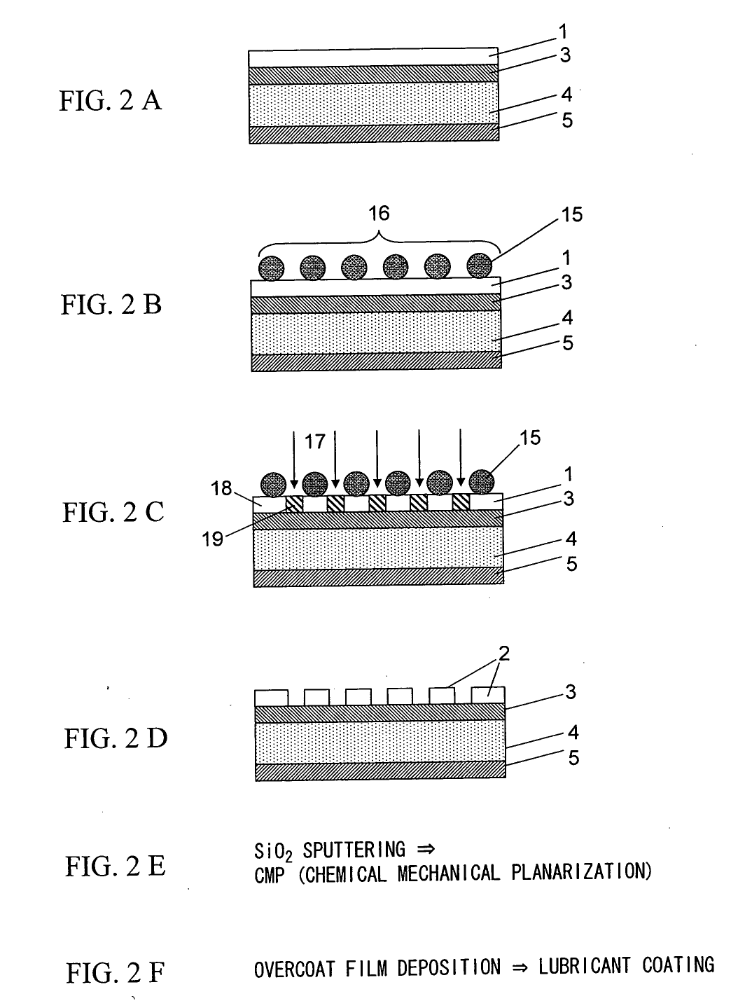

Using FIGS. 2A to 2F, a fabrication technique of magnetic grains by use of a nano particle layer as a mask according to the present invention will be described. First, as a first step, as shown in FIG. 2A, a magnetic layer 1 on which magnetic recording is performed is deposited on a substrate 5. A soft underlayer 4, an intermediate layer 3 and the like may be formed between the substrate 5 and the magnetic layer 1. As a second step, as shown in FIG. 2B, a nano particle layer 16 made of nano particles 15 is formed on the magnetic layer 1. As a third step, as shown in FIG. 2C, the magnetic layer 1 is etched by gas or ions denoted by reference numeral 17 by use of the nano particle layer 16 as a mask. At this time, portions of the magnetic layer 1, which are denoted by reference numeral 18, are masked with the nano particles 15 and are therefore not etched. Portions of the magnetic layer 1, which are denoted by reference numeral 19, are regions where nano particles do not exist thereon, and are therefore etched. Then, when the nano particle layer is removed, magnetic grains 2 are obtained as shown in FIG. 2D. Thereafter, as shown in FIG. 2E, a SiO₂ sputtering step and a chemical mechanical planarization (CMP) step may be provided to fill in and planarize the uneven surface of the processed magnetic grains. Moreover, it is also effective to provide the step of forming an overcoat film on each of the recording media and applying a lubricant thereto as shown in FIG. 2F.

It should be noted that in FIG. 2C, the magnetic layer 1 is etched by the gas or ions denoted by reference numeral 17 by use of the nano particle layer 16 as a mask. That is, the nano particle layer 16 is placed directly on the magnetic layer 1. However, the present invention is not limited to this. It is also possible to add the step of forming at least one thin film (hard mask) made of a material different from that of the magnetic layer 1 between the magnetic recording layer 1 and the nano particle thin film 16. That is, it is also possible to employ the following technique: first, by use of the nano particle layer 16 as a mask, this hard mask is etched to transfer the shapes of the nano particles to the hard mask; then, by use of this hard mask as a mask, the magnetic layer 1 is etched, thus ultimately obtaining magnetic grains to which the shape of the nano particle layer is transferred. This technique is effective in a case where the thickness of the magnetic layer 1 to be subjected to the fine patterning is extremely larger than the diameter of the nano particles.

At this time, as the magnetic layer formed on the substrate, it is possible to use a material containing at least one element selected from Fe, Co, Ni, Mn, Sm, Nd, Pt, Pd and Cr. Furthermore, it is also possible to use a magnetic layer made of an intermetallic compound, a binary alloy, a ternary alloy, an amorphous material, or an oxide, of any of these elements. As specific examples, it is possible to use a Co film, a CoPt film, a FePt film, a CoCrPt film, a multilayer film made of Co and Pd, a multilayer film made of Fe and Pt, a multilayer film made of FePt and Pt or the like used for magnetic recording. In order to provide for higher recording densities in the future, it is possible to use FePt, FePd, CoPt or CoPd having large uniaxial anisotropy constants (Ku). Alternatively, it is also possible to use a magnetic layer made of a ternary alloy made by adding a third element to FePt, FePd, CoPt or CoPd. As the third element, is possible to use Cu, Ag, Au, Ru, Rh, Ir, Pb, Bi or B. It is also possible to use a third element other than these. Moreover, it is also possible to use a composite film which is based on such a film and to which other element or component is added. Other than these, it is also possible to use a granular film which essentially contains CoPt and to which a material essentially containing Si oxide is added. It is also possible to use a TbFeCo alloy film used in magneto-optical recording or a film made by adding other component thereto. It is also possible to use a magnetic layer having a composition which is not described here. As the magnetic layer for magnetic recording, which is formed on the substrate, is possible to use a magnetic layer which is used in any recording system of longitudinal magnetic recording, perpendicular magnetic recording and magneto-optical recording.

As the nano particle layer formed on a desired portion of the magnetic layer, it is possible to use a film made of nano particles containing at least one element selected from Au, Pt, Pd, Si and Al. With regard to the composition of the nano particles, it is also possible to use an intermetallic compound, a binary alloy or a ternary alloy of any of these elements. For the material constituting the nano particles, it is important to select a material which is less likely to be etched than the material constituting the magnetic layer to be etched. This enables the nano particle layer to serve as a favorable mask during the etching of the magnetic layer. It is also possible to use nano particles having a composition which is not described here.

As a fabrication technique of the nano particle layer, it is possible to use the Langmuir-Blodgett (LB) method or the spin coating method. By these two methods, it is possible to form the nano particle layer over the entire surface of the magnetic layer. It is also possible to use a method other than these. In the LB method and the spin coating method, the nano particle layer which serves as a mask is formed directly on the magnetic layer to be processed. Accordingly, it is possible to enhance throughput in mass production, and to produce recording media at low cost.

It is desirable that the nano particles constituting the nano particle layer be substantially spherical in shape, have arbitrary and specific diameters in the range of 1 mm to 10 nm, and have grain diameter dispersion of not more than 10%. It is desirable to use a nano particle layer in which these nano particles are substantially regularly arranged in a monolayer. It is easy to fabricate substantially spherical nano particles having diameters of not less than 1 nm and not more than 10 nm, and this size is suitable for the fine patterning of the magnetic layer for fabricating artificial granular media. The use of nano particles having grain diameter dispersion of not more than 10% maintains the evenness of the nano particle layer, and facilitates the dimension control of magnetic grains which are to be obtained by etching performed later.

The nano particle layer obtained as described above and laid on the magnetic layer is used as a mask when the magnetic layer is etched. At this time, as an etching method, it is possible to use ion milling, FIB or RIE. In FIB, etching is performed mainly using Ga ions. It is also possible to use ions other than Ga ions. In a case where RIE is used as an etching method, a gas mixture essentially containing halogen typified by chlorine, CO, or CO₂ and NH₃ is mainly used as etching gas for the magnetic layer. It is also possible to use etching gas other than these.

The magnetic grains formed in the magnetic layer by etching by use of the nano particle layer as a mask as described above have shapes reflecting the shapes of the nano particles. In the case where spherical nano particles are used, the magnetic layer becomes cylindrical magnetic grains after etching. If conditions for FIB or RIE are optimized, it is possible to make the diameters of substantially cylindrical and convex magnetic grains formed in the magnetic layer substantially equal to the diameters of the spherical nano particles. It is easy to fabricate spherical nano particles having diameters of not less than 1 nm and not more than 10 nm by chemical synthesis.

It is possible to use the magnetic grains, which are obtained by etching performed by use of the nano particle layer as an etching mask as described above and which have grain diameters of not less than 1 nm and not more than 10 nm, as recording media in which the plurality of (two or more) magnetic grains constitute one recorded bit. In this case, as a recording mode, it is possible to use longitudinal magnetic recording, perpendicular magnetic recording, or optical or thermal assisted magnetic recording.

Although metal nano particles have been described here, it is also possible to similarly employ nano particles or the like made of an oxide such as silica (SiO₂) or alumina (Al₂O₃), or an organic matter such as polystyrene.

As nano particles made of an oxide or an organic matter such as silica, alumina or polystyrene, it is possible to employ commercially available nano particles. With the development of nanotechnology, nano particles made of these oxides and organic matters, which have various grain diameters, are commercially available in the form of a colloidal solution as polishing or filling materials. Out of these commercially available products, it is possible to use nano particles having diameters of not more than 10 nm and dispersion of not more than 10% as nano particles for a mask. As a fabrication technique of the nano particle layer, it is possible to use the LB method or the spin coating method as in the case of metal nano particles. By optimizing deposition conditions, it is possible to obtain a monolayer in which nano particles made of an oxide or an organic matter such as silica, alumina or polystyrene are substantially regularly arranged.

The present invention will be more specifically described below. However, the present invention is not limited by these examples.

### EXAMPLE 1

First, nano particles serving as a mask material were prepared. Several fabrication techniques of nano particles are known. However, in order to obtain nano particles having uniform diameters and having grain diameter dispersion of not more than 10%, the following chemical synthesis method is optimum. In an organic solvent or a water-containing inorganic solvent, metal nano particles having arbitrary grain diameters are obtained by use of nuclear growth of metal atoms obtained by reducing metal ions serving as a raw material, or of metal atoms obtained by removing organic compounds coordinated around the metal atoms. The metal ions or metal atoms serving as a raw material may be of a single element or a plurality of elements. In the case of the plurality of elements, alloy nano particles are obtained. It is possible to control the grain diameters in the range of not more than 100 nm, by optimizing factors such as the structure of an organic compound which is called a ligand and which surrounds the metal nano particles, the combination of a plurality of ligands, the amount of ligands attached to the raw material, and the timing of adding ligands during the synthesis process. Moreover, it is possible to obtain nano particles having desired shapes by optimizing factors such as the structure of an organic compound serving as the ligands and the combination of the ligands. The most general shape of nano particles obtained by chemical synthesis is a spherical shape or a regular polyhedron structure. It is also possible to synthesize spindle-shaped nano particles by combining two or more kinds of ligands.

It is possible to reduce the grain diameter dispersion of nano particles to 10% or less by centrifuging a solution of the nano particles obtained by the above-described chemical synthesis and selecting only the nano particles having specific diameters (i.e., specific weights) by the weights thereof. The molecular structure of ligands surrounding the nano particles becomes an important factor which determines the nano particle distance when the nano particle layer is formed. That is, the nano particle distance corresponds to the magnetic grain distance of finished magnetic recording media, and relates to the control of exchange interaction. If a ligand having a high molecular weight and a long-chain structure is used, the distance among particles becomes large in the nano particle layer. On the other hand, if a ligand having a small carbon number and a low molecular weight is used, the distance among particles becomes small in the nano particle layer. It is known that in a case where oleic acid, which is often used for Co or Fe nano particles, is used as a ligand, the distance among nano particles becomes 2 to 4 nm. In a case where hexanoic acid, which has a lower molecular weight than oleic acid, is used as a ligand, the distance among nano particles becomes as small as 1 to 2 nm.

It has been described above that the control of the distance among nano particles, i.e., the control of the magnetic grain distance, relates to the control of exchange interaction of magnetic recording media. In the magnetic recording media, from the viewpoints of resolution characteristics and thermal demagnetization characteristics, exchange interaction needs to take on a certain appropriate value.

Next, Au nano particles were prepared using the above-described chemical synthesis method. A reason for selecting Au as the material of nano particles is that it has sufficient etching resistance as a mask for etching the magnetic layer. An actual synthesis method is described below. Au ions were reduced in an organic solution, thus obtaining a colloidal solution of Au nano particles. This solution was centrifuged to perform fractionation depending on sizes, thus obtaining a colloidal solution of Au nano particles which had grain diameter dispersion of 10% and in which the diameter of metal nuclei was 5 nm. At this time, the Au nano particles were coated with dodecanethiol (CH₃—(CH₂)₁₁—SH), which is an organic compound having a length of 4 nm, and were dispersed as colloid in an alcohol solvent.

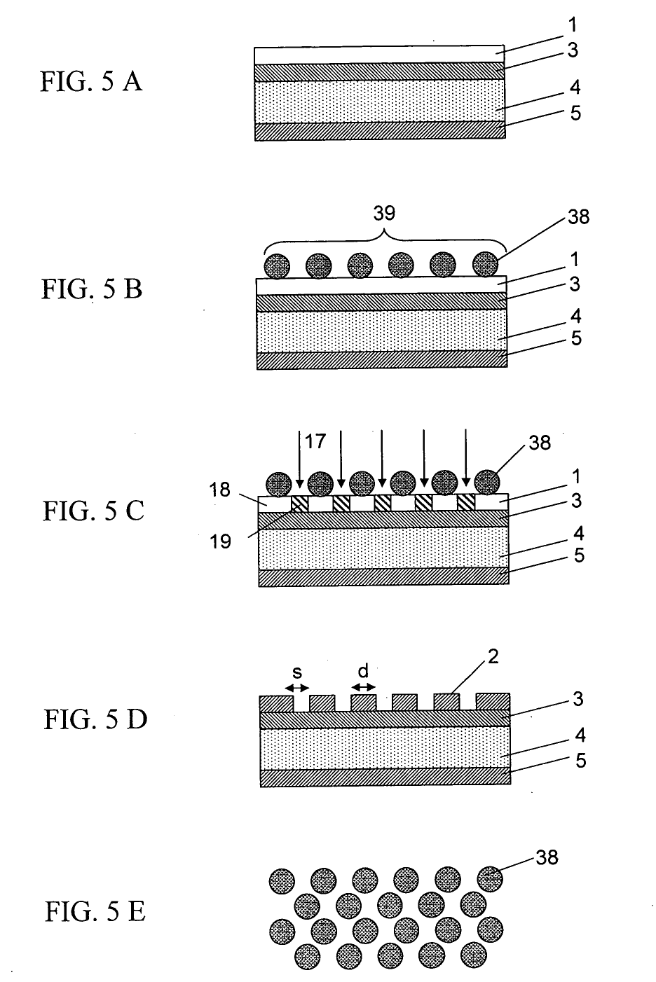

Next, as shown in FIG. 5A, the soft underlayer 4, the intermediate layer 3, and the magnetic layer 1 which serves as a magnetic recording layer were deposited in this order on the substrate 5 made of glass by sputtering. The soft underlayer essentially contained Co and had a thickness of 100 nm. The intermediate layer essentially contained Ru and had a thickness of 20 nm. As the magnetic recording layer, a CoCrPt film (20 nm in thickness) having perpendicular anisotropy was used. The above-described colloidal solution of Au nano particles was dropped on the magnetic layer to be spread by spin coating, and the substrate was then pre-baked at 60° C. for 10 minutes, thus completely evaporating the spread solvent. In the spin coating method, it is possible to form a film made of nano particles which are closest packed and substantially regularly arranged over the entire surface of the magnetic layer, by selecting the molecular weight and molecular structure of the compound coating the nano particles, adjusting the concentration of the colloidal solution, and optimizing spin conditions. In this example, a nano particle layer in which Au nano particles were substantially regularly arranged in a monolayer was obtained by using a colloidal solution of Au nano particles which were coated with dodecanethiol having a length of 4 nm and which had a diameter of 5 nm, and by optimizing spin coating conditions. A ligand of the Au nano particles used in this example is dodecanethiol having a high self-assembling tendency. Accordingly, though spin coating was performed, particle arrangement after spin coating was a substantially regular hexagonal lattice as shown in FIG. 5E when viewed from above the substrate. As a result, a monolayer 39 in which Au nano particles 38 were substantially regularly arranged as shown in FIG. 5B was formed over the entire surface of the magnetic layer.

Next, as shown in FIG. 5C, by use of the nano particle layer as a mask, the CoCrPt film of the magnetic layer 1 was anisotropically dry-etched (RIE) (reference numeral 17) by a gas mixture of CO and NH₃. Since the etching mask used in this example is the Au nano particle layer, the etching mask has higher dry-etching resistance than conventional resist masks, and is less worn during etching. Accordingly, it is possible to accurately transfer a mask pattern to the magnetic layer by RIE. In this example, the regions 18 covered with the Au nano particles 38 were not etched, and the regions 19 without nano particles were etched by the etching gas. Thus, as shown in FIG. 5D, a favorable fine pattern having a grain diameter d of 5 nm and an intergranular distance of 3 nm was fabricated in the magnetic layer 1 on the substrate.

This substrate was evaluated for magnetic characteristics by use of a vibrating sample magnetometer. As a result, obtained was a magnetization curve showing favorable magnetic characteristics: a perpendicular coercivity of 6000 Oe, a coercivity squareness ratio S* of 0.85, and a residual magnetization of 150 emu/cc. By the above-described patterning, artificial granular perpendicular magnetic recording media showing favorable magnetic characteristics were fabricated.

To each of the artificial granular perpendicular magnetic recording media fabricated in this example, an overcoat film essentially containing carbon was attached, and a fluorinated lubricant was applied. Each of the media was combined with a thin-film magnetic monopole write head and a GMR-element-based read head (read-write separation type heads) for perpendicular magnetic recording, and an evaluation was performed using a spin stand (read and write characteristic evaluation facility).

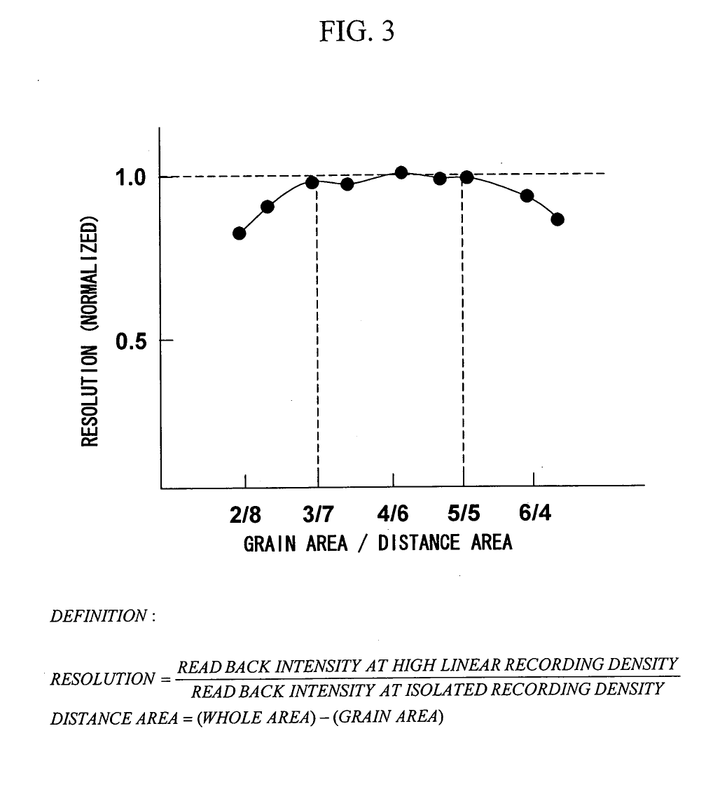

Various nano particle layers were fabricated (i.e., fabricated in such a manner that the size of nano particles and the distance among particles (interparticle distance) were changed variously) to fabricate artificial granular magnetic recording media, and these were evaluated for the aforementioned resolution characteristics, thus evaluating optimum values of the grain diameters and intergranular distances of magnetic grains of the artificial granular magnetic recording media. The result of this is shown in FIG. 3. Resolution is represented by the following equation:
Resolution=(Read Back Intensity at High Linear Recording Density)/(Read Back Intensity at Isolated Recording Density)

Here, a recorded pattern had high linear recording density of 800 kFCI (Flux Changes per Inch), and isolation was 5 kFCI. With regard to resolution, a value of 7% was obtained in the range in which (grain area)/(distance area)=3/7 to 5/5 (represented by normalized resolution in FIG. 3). At other values of (grain area)/(distance area), a deterioration of the resolution characteristic was observed. Thus, it was revealed that the above-described resolution characteristic was the most excellent in the recording media in which the ratio of grain area to distance area (grain area)/(distance area) was in the range of 3/7 to 5/5.

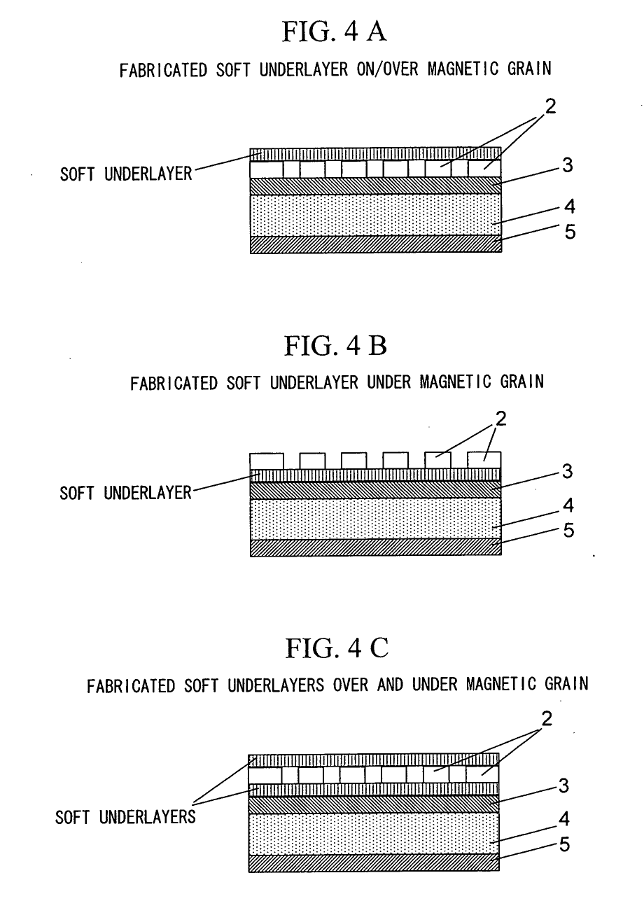

Moreover, it is possible to control the intensity of exchange interaction by forming a material or materials having higher magnetic permeability than the magnetic grains fabricated by patterning over, under, or both over and under the magnetic grains fabricated by patterning (see FIGS. 4A to 4C), instead of controlling grain area and intergranular distance. Thus, it is possible to reduce the coercivity Hc of the recording media. That is, it is possible to reduce a required recording head magnetic field. As the material thereof, it suffices to use a soft underlayer such as Permalloy. The soft underlayer is not limited to Permalloy. It suffices to use a material having higher magnetic permeability than the magnetic grains fabricated by fine patterning. Here, when Permalloy having a film thickness of 10 nm was used, the effect of reducing a medium coercivity Hc by 1000 Oe was confirmed.

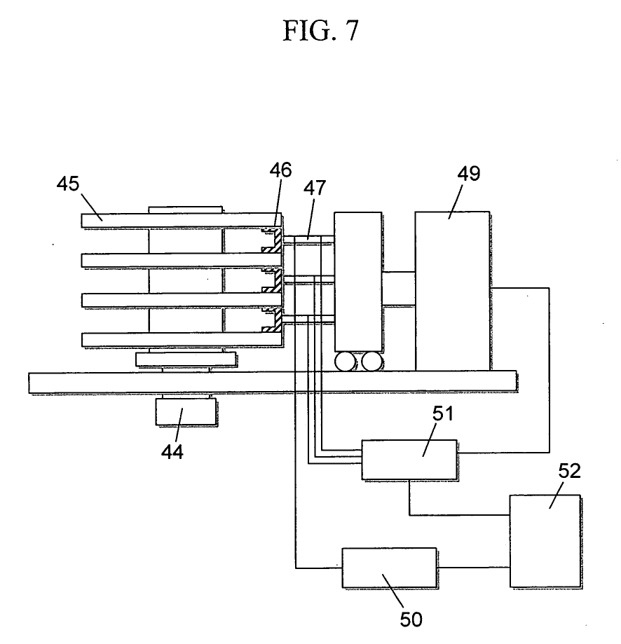

Next, a hard disk drive schematically shown in FIG. 7 was assembled. In FIG. 7, reference numeral 44 denotes a spindle motor for rotationally driving the recording media, 45 denotes hard disks which are the artificial granular recording media, 46 denotes magnetic heads each including a read portion and a write portion, 47 denotes magnetic head suspensions for respectively holding the heads, and 49 denotes a voice coil motor for positioning the magnetic heads. Furthermore, reference numeral 51 denotes an electric circuit for read/write, 50 denotes an electric circuit for magnetic head positioning, and 52 denotes an electric circuit for interface control. A read/write experiment was performed using this hard disk drive, and a read back output was investigated. As a result, when recording density was 800 kFCI, an output of approximately 1 mV was obtained on a peak-to-peak basis. Moreover, it was found that wear resistance was at a level similar to those of conventional media fabricated by sputter deposition.

### EXAMPLE 2

A Au nano particle monolayer was formed over the entire surface of the magnetic layer by the Langmuir-Blodgett (LB) method instead of the spin coating method used in example 1. In this example, a colloidal solution of Au nano particles which were coated with dodecanethiol having a length of 4 nm and which had a diameter of 5 mm, as in the case of example 1.

Hereinafter, the formation of a nano particle layer by the LB method will be described. An LB film is formed by dropping a colloidal solution of metal nano particles on a surface of clean water in a trough little by little to make a monolayer of nano particles on the water surface, and moving a movable barrier plate to compress the monolayer floating on the water surface slowly and gently. First, bottom and edge portions of the trough (water tank) and the movable barrier plate of an LB film fabricating device were cleaned with acetone. The trough was filled with ion-exchanged water, and the height of the water surface raised by surface tension was adjusted to approximately 0.5 mm below the edge of the trough. Next, a surface pressure gauge and the movable barrier plate were set to predetermined positions. A nano particle colloidal solution in a microsyringe was dropped gently drop by drop at different places on the water surface, thus expanding nano particles over the water surface. The concentration of the dropped Au colloidal solution was set at approximately 1 μmol/l, and the expanded amount thereof was set at approximately 1000 μl for an expanded area of 600 cm². After the nano particles were expanded over the water surface, they were set aside for 30 minutes until the expansion solvent completely evaporated. Next, the movable barrier plate was moved at a compressing speed of 7.2 cm²/min., and the nano particle monolayer formed on the water surface was compressed while the surface pressure was being monitored. The compression was stopped when the surface pressure was 10 to 20 mN/m. As a result, a closest-packed Au nano particle monolayer having a substantially regular arrangement was obtained. The Au nano particle monolayer formed by the LB method was transferred to a surface-hydrophobized substrate made of glass or Si by the horizontal lifting method. As a surface-hydrophobizing agent, iron (III) stearate or epoxidized butadiene was used. The Au nano particle monolayer transferred to the substrate was left at rest in a clean bench to remove moisture naturally.

Using the Au nano particle monolayer formed by the LB method as described above as a mask, the magnetic layer was anisotropically dry-etched using a gas mixture of CO and NH₃, as in the case of example 1. Thus, favorable artificial granular magnetic recording media having a grain diameter d of 5 nm and an intergranular distance s of 3 nm were fabricated over the entire surface of the substrate as in FIG. 5D.

As in the case of example 1, the substrate having a fine pattern formed thereon by the above-described method was evaluated for magnetic characteristics using a vibrating sample magnetometer. As a result, obtained was a magnetization curve showing favorable magnetic characteristics: a perpendicular coercivity of 6000 Oe, a coercivity squareness ratio S* of 0.85, and a residual magnetization of 150 emu/cc. By the above-described patterning, artificial granular perpendicular magnetic recording media showing favorable magnetic characteristics were fabricated.

To each of the artificial granular perpendicular magnetic recording media fabricated in this example, an overcoat film and a fluorinated lubricant were applied as in the case of example 1, thus making artificial granular perpendicular recording media for evaluation. Each of the media was combined with a head of a read-write separation type which includes a thin-film magnetic monopole write head for perpendicular magnetic recording and a GMR-element-based read head, and a hard disk drive schematically shown in FIG. 7 was assembled, thus investigating an output. As a result, when recording density was 800 kFCI, an output of approximately 1 mV was obtained on a peak-to-peak basis. Moreover, it was found that wear resistance was at a level similar to those of conventional media fabricated by sputter deposition.

### EXAMPLE 3

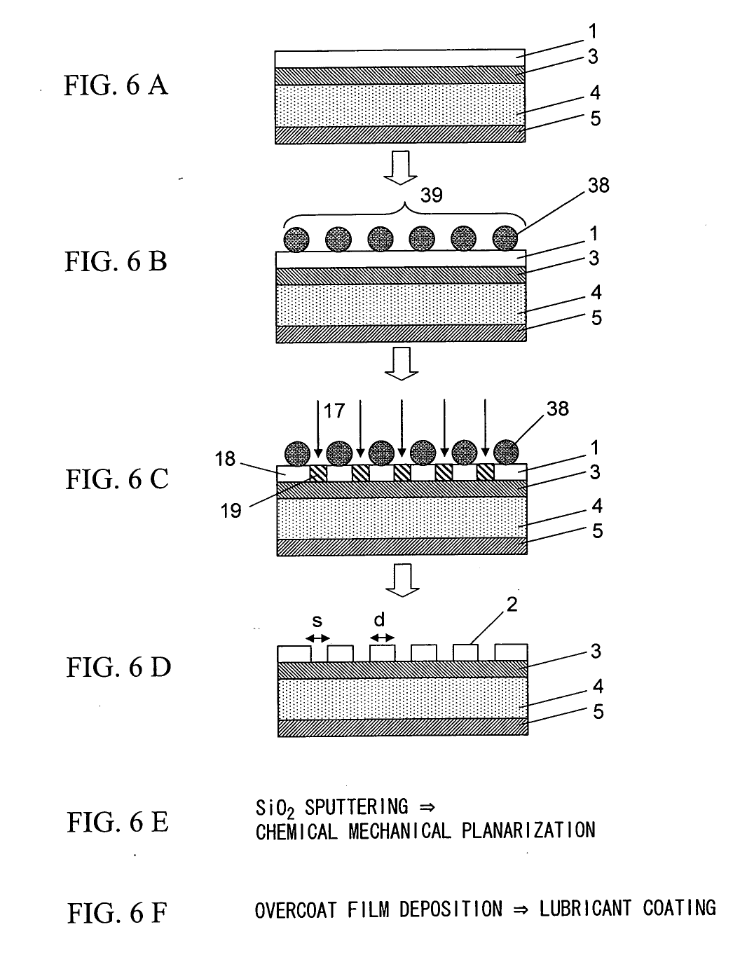

Using a multilayer film made of Co and Pd (hereinafter abbreviated as a Co/Pd multilayer film) as a magnetic layer, magnetic grains were fabricated in the magnetic layer by the steps shown in FIGS. 6A to 6F. As shown in FIG. 6A, as a first step, a soft underlayer 4 essentially containing Co, an intermediate layer 3 essentially containing Ru and Ta, and the magnetic layer (Co/Pd multilayer film) 1 for perpendicular magnetic recording were deposited in this order on a substrate 5. As shown in FIG. 6B, as a second step, a Au nano particle layer 39 was formed over the entire surface of the magnetic layer 1. Nano particles used at this time were spherical Au particles 38 which were coated with oleic acid and oleyl amine and which had a diameter of 3 nm. As shown in FIG. 6C, as a third step, using the Au nano particle layer as a mask, the Co/Pd multilayer film was subjected to RIE using a gas mixture of CO and NH₃ denoted by reference numeral 17. The regions 18 covered with the Au nano particles 38 were not etched, and the regions 19 without nano particles were etched by the gas. As a result, as shown in FIG. 6D, in the Co/Pd multilayer film 1, a favorable artificial granular magnetic recording medium having a grain diameter d of 3 nm and an intergranular distance s of 2 nm was fabricated.

As in the case of example 1, the substrate having a fine pattern formed thereon by the above-described method was evaluated for magnetic characteristics using a vibrating sample magnetometer. As a result, obtained was a magnetization curve showing favorable magnetic characteristics: a perpendicular coercivity of 6000 Oe, a coercivity squareness ratio S* of 0.85, and a residual magnetization of 150 emu/cc. By the above-described patterning, artificial granular perpendicular magnetic recording media showing favorable magnetic characteristics were fabricated.

To each of the artificial granular perpendicular magnetic recording media fabricated in this example, an overcoat film and a fluorinated lubricant was applied as in the case of example 1, thus making artificial granular perpendicular recording media for evaluation. Each of the media was combined with a head of a read-write separation type which includes a thin-film magnetic monopole write head for perpendicular magnetic recording and a GMR-element-based read head, and a hard disk drive schematically shown in FIG. 7 was assembled, thus investigating an output. As a result, when a recording density was 800 kFCI, an output of approximately 1 mV was obtained on a peak-to-peak basis. Moreover, it was found that wear resistance was at a level similar to those of conventional media fabricated by sputter deposition.

What is claimed is:

1. A magnetic recording medium comprising:
artificially patterned magnetic grains which are fabricated by forming a nano particle thin film over a magnetic recording layer and processing the magnetic recording layer under the nano particle thin film into fine shapes by use of the nano particle thin film as a mask, wherein
the plurality of magnetic grains constitute one recorded bit, and
the magnetic grains each have a grain diameter of not less than 1 nm and not more than 10 nm, and have grain diameter dispersion of not more than 10%.

2. The magnetic recording medium as recited in claim 1, wherein
the patterned magnetic grains are magnetic grains made of any one of Fe, a material essentially containing Fe, Co and a material essentially containing Co.

3. The magnetic recording medium as recited in claim 1, wherein
the patterned magnetic grains are magnetic grains which have a multilayer periodic structure including a thin film made of any one of Fe, a material essentially containing Fe, Co and a material essentially containing Co, and a thin film made of any one of Pt, a material essentially containing Pt, Pd and a material essentially containing Pd.

4. The magnetic recording medium as recited in claim 1, wherein
a ratio of grain area to distance area is in a range of 3/7 to 5/5.

5. The magnetic recording medium as recited in claim 1, wherein
at least one layer made of a material having higher magnetic permeability than the magnetic grains is formed over and/or under the patterned magnetic grains.

6. A method of fabricating a magnetic recording medium including artificially patterned magnetic grains, wherein
the plurality of magnetic grains constitute one recorded bit,
the method comprising the steps of:
forming a nano particle thin film over a magnetic recording layer; and
processing the magnetic recording layer under the nano particle thin film into fine shapes by use of the nano particle thin film as a mask.

7. The method of fabricating a magnetic recording medium as recited in claim 6, the method further comprising the step of
forming at least one thin film between the magnetic recording layer and the nano particle thin film.

8. The method of fabricating a magnetic recording medium as recited in claim 6, wherein
the nano particle thin film is a thin film made of nano particles including at least one kind of material selected from the group consisting of Au, Pt, Pd, polystyrene, silica (SiO₂) and alumina (Al₂O₃), in which the nano particles are substantially regularly arranged in a monolayer, the nano particles are substantially spherical in shape, and the nano particles each have a certain fixed grain diameter of not less than 1 nm and not more than 10 nm, and have grain diameter dispersion of not more than 10%.

9. A hard disk drive comprising:
a magnetic recording medium including a magnetic recording layer;
a driving unit for driving the magnetic recording medium;
a magnetic head for performing a read and a write on the magnetic recording medium;
means for moving the magnetic head relatively to the magnetic recording medium;
means for outputting a recording signal to the magnetic head; and
means for reproducing an output signal from the magnetic head, wherein
the magnetic recording medium is a magnetic recording medium in which two or more artificially patterned magnetic grains constitute one recorded bit, and
the magnetic grains each have a grain diameter of not less than 1 nm and not more than 10 nm, and have grain diameter dispersion of not more than 10%.
